(19) United States
(12) Patent Application Publication
(10) Pub. No.: US 2012/0070421 A1
(43) Pub. Date: Mar. 22, 2012

(54) Synergistic Fungicidal Mixtures

(75) Inventors: Jochen Dietz, Karlsruhe (DE); Egon Haden, Ludwigshafen (DE); Thomas Grote, Wachenheim (DE); Markus Gewehr, Kastellaun (DE); Silke Stoltz, Neidenfels (DE)

(73) Assignee: BASF SE, Ludwigshafen (DE)

(21) Appl. No.: 13/375,520

(22) PCT Filed: May 31, 2010
(86) PCT No.: PCT/EP2010/057517

§ 371 Date: Dec. 1, 2011

(30) Foreign Application Priority Data
Jun. 5, 2009 (EP) 09162101.1

(51) Int. Cl. A01N 63/00; A01P 3/00; A01N 43/78; A01N 63/02; A01N 43/90

(52) U.S. Cl. 424/93.462; 424/93.46; 424/115; 514/259.31; 514/319

(57) ABSTRACT

The present invention relates to fungicidal mixtures, comprising a compound of formula I and one fungicidal component II selected from groups A′) to C′) as defined in the description, and to compositions comprising these mixtures.

The present invention relates to mixtures comprising, as active components
1) at least one compound of the formula I

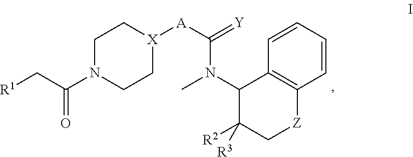

where:
R¹ is 1H-pyrazol-1-yl or phenyl, wherein the two aforementioned radicals are unsubstituted or carry 1 or 2 identical or different substituents R^{a};
   R^{a} is halogen, CH₃, CH₂CH₅ or CF₃;
X is CH or N;
Y is O or S;
A is a 5-membered heteroarenediyl, wherein the ring member atoms include, besides carbon atoms 1 sulfur atom and 1 nitrogen atom, or 1 oxygen atom and 1 nitrogen atom, or 2 or 3 nitrogen atoms;
Z is a divalent radical selected from —CH₂—, —CHOH— and ═C═O;
R², R³ independently of each other are selected from hydrogen and CH₃;
and the N-oxides and the agriculturally acceptable salts of the compounds of the formula I;
   and
   2) at least one fungicidal component II selected from groups A′) to C′):

A′) carboxanilides selected from the group consisting of isopyrazam and 3-difluoromethyl-1-methyl-1H-pyrazole-4-carboxylic acid (3′,4′,5′-trifluorobiphenyl-2-yl)-amide;

B′) 5-ethyl-6-octyl-[1,2,4]triazolo[1,5-a]pyrimidine-7-ylamine;

C′) a fungicidal strain selected from the Bacillus subtilis strain AQ713 with NRRL Accession No. B-21661, the Bacillus pumilus strain with NRRL Accession No. B-30087, and mutants or variants of the aforementioned Bacillus strains having all the identifying characteristics of the respective strain, or a culture broth or a supernatant obtained from a culture of the aforementioned Bacillus strains;
or a metabolite produced by an aforementioned Bacillus strain that exhibits activity against plant pathogenic fungi;

in a synergistically effective amount.

Moreover, the invention relates also to a method for controlling phytopathogenic harmful fungi using mixtures of a compound of formula I (herein also referred to as compounds I) and at least one fungicidal component II and to the use of compounds I and fungicidal components II for preparing such mixtures, and to compositions and seed comprising these mixtures.

Practical agricultural experience has shown that the repeated and exclusive application of an individual active compound in the control of harmful fungi leads in many cases to a rapid selection of those fungus strains which have developed natural or adapted resistance against the active compound in question. Effective control of these fungi with the active compound in question is then no longer possible.

To reduce the risk of the selection of resistant fungus strains, mixtures of different active compounds are nowadays conventionally employed for controlling harmful fungi. By combining active compounds having different mechanisms of action, it is possible to ensure successful control over a relatively long period of time.

It is an object of the present invention to provide, with a view to effective resistance management and effective control of phytopathogenic harmful fungi, at application rates which are as low as possible, compositions which, at a reduced total amount of active compounds applied, have improved activity against the harmful fungi (synergistic mixtures) and a broadened activty spectrum, in particular for certain indications.

We have accordingly found that this object is achieved by the compositions, defined herein, comprising compound I and at least one fungicidal component II. Compounds I can have centers of chirality and can be present as pure (R)- or (S)-isomer or as isomer mixtures. Both, the pure isomers and their mixtures are in mixture with at least one fungicidal component II subject matter of the present invention.

Moreover, we have found that simultaneous, that is joint or separate, application of compound I and at least one fungicidal component II or successive application of a compound I and of a fungicidal component II allows better control of harmful fungi than is possible with the individual compounds alone (synergistic mixtures).

Compounds I and/or the fungicidal components II of the inventive compositions can be present in different crystal modifications, which may differ in biological activity.

Compounds I and their fungicidal activity have been described in WO 2007/014290, WO 2008/091594, WO 2008/091580, WO 2008/090181. Fungicidal components II, their preparation and their activity against harmful fungi are known from the references below:

Isopyrazam, a mixture of 2 syn-isomers 3-(difluoromethyl)-1-methyl-N-[(1RS,4SR,9RS)-1,2,3,4-tetrahydro-9-isopropyl-1,4-methanonaphthalen-5-yl]pyrazole-4-carboxamide and 2 anti-isomers 3-(difluoromethyl)-1-methyl-N-[(1RS,4SR,9SR)-1,2,3,4-tetrahydro-9-isopropyl-1,4-methanonaphthalen-5-yl]pyrazole-4-carboxamide, is known from WO 04/035589 and can be prepared in the manner described therein or as described in WO 07/068,417.

Ethyl-6-octyl-[1,2,4]-triazolo[1,5-a]pyrimidine-7-ylamine and its fungicidal activity is known from WO 05/087773.

The fungicidal Bacillus strains, their mutants and the metabolites produced by the strains that exhibit activity against plant pathogenic fungi, referred to above as component C′), their preparation and their action against harmful fungi are known from WO 98/50422, WO 00/29426 and WO 00/58442, therein also referred to as AQ713 (QST713) and QST2808. Mixtures of these strains with certain chemical fungicides structurally not related to compounds I have been mentioned in WO 09/037,242.

NRRL is the abbreviation for the Agricultural Research Service Culture Collection, an international depositary authority for the purposes of deposing microorganism strains under the BUDAPEST TREATY ON THE INTERNATIONAL RECOGNITION OF THE DEPOSIT OF MICROORGANISMS FOR THE PURPOSES OF PATENT PROCEDURE, having the address National Center for Agricultural Utilization Research, Agricultural Research Service, U.S. Department of Agriculture, 1815 North University Street, Peoria, Ill. 61604, USA.

Suitable formulations of the Bacillus subtilis strain AQ713 with NRRL Accession No. B-21661 are commercially available under the tradenames RHAPSODY®, SERENADE® MAX and SERENADE® ASO from AgraQuest, Inc., USA.

Suitable formulations of the Bacillus pumilus strain with NRRL Accession No. B-30087 are commercially available under the tradenames SONATA® and BALLAD® Plus from AgraQuest, Inc., USA.

The group C′) embraces not only the isolated, pure cultures of the Bacillus subtilis strain and the Bacillus pumilus strain, but also their suspensions in a whole broth culture or as a metabolite-containing supernatant or a purified metabolite obtained from a whole broth culture of the strain.

The term “whole broth culture” refers to a liquid culture containing both cells and media. The term “supernatant” refers to the liquid broth remaining when cells grown in broth are removed by centrifugation, filtration, sedimentation, or other means well known in the art. The term “metabolite” refers to any compound, substance or byproduct of a fermentation or a microorganism that has fungicidal activity.

In the definitions of the variables given above, collective terms are used which are generally representative for the substituents in question.

The term “halogen” refers to fluorine, chlorine, bromine and iodine.

The term “5-membered heteroarenediyl, wherein the ring member atoms include, besides carbon atoms 1 sulfur atom and 1 nitrogen atom, or 1 oxygen atom and 1 nitrogen atom, or 2 or 3 nitrogen atoms” is to be understood as meaning an aromatic heterocycles that has two points of attachment. Examples include: 1H-pyrazol-3,5-diyl, 1H-pyrazol-3,4-diyl, 1H-pyrazol-4,5-diyl, 1H-pyrazol-1,3-diyl, 1H-pyrazol-1,4-diyl, oxazol-2,4-diyl, oxazol-2,5-diyl, oxazol-4,5-diyl, thiazol-2,4-diyl, thiazol-2,5-diyl, thiazol-4,5-diyl, imidazol-2,4-diyl, imidazol-2,5-diyl, imidazol-4,5-diyl, 1H-[1,3,4]triazol-2,4-diyl and 1H-[1,2,3]-triazol-4,5-diyl.

Agriculturally acceptable salts of the compounds I encompass especially the salts of those cations or the acid addition salts of those acids whose cations and anions, respectively, have no adverse effect on the fungicidal action of the compounds I. Suitable cations are thus in particular the ions of the alkali metals, preferably sodium and potassium, of the alkaline earth metals, preferably calcium, magnesium and barium, of the transition metals, preferably manganese, copper, zinc and iron, and also the ammonium ion which, if desired, may carry 1 to 4 C₁-C₄-alkyl substituents and/or one phenyl or benzyl substituent, preferably diisopropylammonium, tetramethylammonium, tetrabutylammonium, trimethylbenzylammonium, furthermore phosphonium ions, sulfonium ions, preferably tri(C₁-C₄-alkyl)sulfonium, and sulfoxonium ions, preferably tri(C₁-C₄-alkyl)sulfoxonium. Anions of useful acid addition salts are primarily chloride, bromide, fluoride, hydrogensulfate, sulfate, dihydrogenphosphate, hydrogenphosphate, phosphate, nitrate, bicarbonate, carbonate, hexafluorosilicate, hexafluorophosphate, benzoate, and the anions of C₁-C₄-alkanoic acids, preferably formate, acetate, propionate and butyrate. They can be formed by reacting a compound I with an acid of the corresponding anion, preferably of hydrochloric acid, hydrobromic acid, sulfuric acid, phosphoric acid or nitric acid.

In the inventive mixtures, as compound I, the following compounds are preferred: Preference is given to those compounds I, wherein the substituents and variables X, Y, Z, R¹, R², R³ and A have independently of each other or more preferably in combination the following meanings:

One embodiment relates to mixtures comprising compounds I, wherein R¹ is 1H-pyrazol-1-yl, which pyrazolyl carries 1 or 2 identical or different substituents R^{a}.

Another embodiment relates to mixtures comprising compounds I, wherein R^{a} is selected from CH₃ and CF₃, more preferably from 5-CH₃ and 3-CF₃, and in particular the radical R¹ is substituted by 5-CH₃ and 3-CF₃.

A further embodiment of the invention relates to mixtures comprising compounds I, wherein X is CH.

A further embodiment of the invention relates to mixtures comprising compounds I, wherein Y is O.

A further embodiment of the invention relates to mixtures comprising compounds I, wherein A is selected from thiazol-2,4-diyl, oxazol-2,4-diyl, 1H-pyrazol-3,5-diyl, 1H-pyrazol-4,5-diyl and 1H-[1,2,3]triazol-4,5-diyl, preferably A is thiazol-2,4-diyl, and in particular A is thiazol-2,4-diyl, wherein the carbon atom in position 2 is bound to the variable X and the carbon atom in position 4 is bound to the group C═Y.

A further embodiment relates to mixtures comprising compounds I, wherein Z is the divalent radical —CH₂—.

A further embodiment relates to mixtures comprising compounds I, wherein R² and R³ are both hydrogen.

A further preferred embodiment relates to mixtures, wherein compound I is selected from the group consisting of: 2-[1-[(2,5-dimethylphenyl)acetyl]-4-piperidinyl]-N-methyl-N-[(1R)-1,2,3,4-tetrahydro-1-naphthalenyl]-4-thiazolecarboxamide, 2-[1-[(2,5-dichlorophenyl)acetyl]-4-piperidinyl]-N-methyl-N-[(1R)-1,2,3,4-tetrahydro-1-naphthalenyl]-4-thiazolecarboxamide, N-methyl-2-[1-[[5-methyl-3-(trifluoromethyl)-1H-pyrazol-1-yl]acetyl]-4-piperidinyl]-N-[(1R)-1,2,3,4-tetrahydro-1-naphthalenyl]-4-thiazolecarboxamide, N-[(1R)-2,3-dihydro-1H-inden-1-yl]-N-methyl-2-[1-[[5-methyl-3-(trifluoromethyl)-1H-pyrazol-1-yl]acetyl]-4-piperidinyl]-4-thiazolecarboxamide, N-methyl-2-[1-[[5-methyl-3-(trifluoromethyl)-1H-pyrazol-1-yl]acetyl]-4-piperidinyl]-N-[(1R)-1,2,3,4-tetrahydro-1-naphthalenyl]-4-thiazolecarbothioamide, N-methyl-2-[1-[[5-methyl-3-(trifluoromethyl)-1H-pyrazol-1-yl]acetyl]-4-piperidinyl]-N-[(1R,4S)-1,2,3,4-tetrahydro-4-hydroxy-1-naphthalenyl]-4-thiazolecarboxamide and its enantiomer, N-methyl-2-[1-[[5-methyl-3-(trifluoromethyl)-1H-pyrazol-1-yl]acetyl]-4-piperidinyl]-N-(1,2,3,4-tetrahydro-2-methyl-1-naphthalenyl)-4-thiazolecarboxamide, N-methyl-2-[1-[[5-methyl-3-(trifluoromethyl)-1H-pyrazol-1-yl]acetyl]-4-piperidinyl]-N-[(1R,4R)-1,2,3,4-tetrahydro-4-hydroxy-1-naphthalenyl]-4-thiazolecarboxamide and its enantiomer(s),2-[1-[[5-ethyl-3-(trifluoromethyl)-1H-pyrazol-1-yl]acetyl]-4-piperidinyl]-N-methyl-N-[(1R)-1,2,3,4-tetrahydro-1-naphthalenyl]-4-thiazolecarboxamide, 2-[1-[[3,5-bis(trifluoromethyl)-1H-pyrazol-1-yl]acetyl]-4-piperidinyl]-N-methyl-N-[(1R)-1,2,3,4-tetrahydro-1-naphthalenyl]-4-thiazolecarboxamide, N-methyl-2-[1-[[5-methyl-3-(trifluoromethyl)-1H-pyrazol-1-yl]acetyl]-4-piperidinyl]-N-(1,2,3,4-tetrahydro-4-oxo-1-naphthalenyl)-4-thiazolecarboxamide, N-methyl-2-[4-[[5-methyl-3-(trifluoromethyl)-1H-pyrazol-1-yl]acetyl]-1-piperazinyl]-N-[(1R)-1,2,3,4-tetrahydro-1-naphthalenyl]-4-thiazolecarboxamide, N-(2,3-dihydro-2,2-dimethyl-1H-inden-1-yl)-N-methyl-2-[1-[[5-methyl-3-(trifluoromethyl)-1H-pyrazol-1-yl]acetyl]-4-piperidinyl]-4-thiazolecarboxamide, N-(2,3-dihydro-2-methyl-1H-inden-1-yl)-N-methyl-2-[1-[[5-methyl-3-(trifluoromethyl)-1H-pyrazol-1-yl]acetyl]-4-piperidinyl]-4-thiazolecarboxamide, N-methyl-1-[1-[[5-methyl-3-(trifluoromethyl)-1H-pyrazol-1-yl]acetyl]-4-piperidinyl]-N-[(1R)-1,2,3,4-tetrahydro-1-naphthalenyl]-1H-pyrazole-3-carboxamide, N-methyl-2-[1-[[5-methyl-3-(trifluoromethyl)-1H-pyrazol-1-yl]acetyl]-4-piperidinyl]-N-[(1R)-1,2,3,4-tetrahydro-1-naphthalenyl]-2H-1,2,3-triazole-4-carboxamide, N-methyl-1-[1-[[5-methyl-3-(trifluoromethyl)-1H-pyrazol-1-yl]acetyl]-4-piperidinyl]-N-[(1R)-1,2,3,4-tetrahydro-1-naphthalenyl]-1H-pyrazole-4-carboxamide, N-methyl-2-[1-[[5-methyl-3-(trifluoromethyl)-1H-pyrazol-1-yl]-acetyl]-4-piperidinyl]-N-[(1R,2S)-1,2,3,4-tetrahydro-2-methyl-1-naphthalenyl]-4-thiazolecarboxamide and its enantiomer, N-methyl-2-[1-[[5-methyl-3-(trifluoromethyl)-1H-pyrazol-1-yl]acetyl]-4-piperidinyl]-N-(1,2,3,4-tetrahydro-2,2-dimethyl-1-naphthalenyl]-4-thiazolecarboxamide, 2-[1-[(3,5-dichloro-1H-pyrazol-1-yl)acetyl]-4-piperidinyl]-N-methyl-N-[(1R)-1,2,3,4-tetrahydro-1-naphthalenyl]-4-thiazolecarboxamide, 2-[1-[[5-chloro-3-(trifluoromethyl)-1H-pyrazol-1-yl]acetyl)-4-piperidinyl)-N-methyl-N-](1R)-1,2,3,4-tetrahydro-1-naphthalenyl]-4-thiazolecarboxamide, N-methyl-2-[1-[[5-methyl-3-(trifluoromethyl)-1H-pyrazol-1-yl)acetyl]-4-piperidinyl]-N4 (1R)-1,2,3,4-tetrahydro-1-naphthalenyl]-4-oxazolecarboxamide, and N-methyl-2-[1-[[5-methyl-3-(trifluoromethyl)-1H-pyrazol-1-yl]acetyl]-4-piperidinyl]-N-(1,2,3,4-tetrahydro-1-naphthalenyl)-4-thiazolecarboxamide.

A particularly preferred embodiment relates to mixtures wherein compound I is 2-{1-[2-(5-methyl-3-trifluoromethyl-pyrazol-1-yl)-acetyl]-piperid-4-yl}-thiazole-4-carboxylic acid methyl-(R)-1,2,3,4-tetrahydro-naphthalen-1-yl-amide of formula

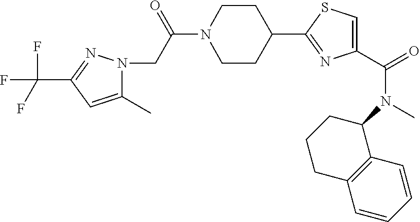

and/or its enantiomer.

According to one embodiment, the inventive mixtures comprise as component II isopyrazam.

According to a further embodiment, mixtures comprise as component II the compound 3-difluoromethyl-1-methyl-1H-pyrazole-4-carboxylic acid (3′,4′,5′-trifluorobiphenyl-2-yl)-amide.

According to a further embodiment, mixtures comprise as component II the compound 5-ethyl-6-octyl-[1,2,4]triazolo[1,5-a]pyrimidine-7-ylamine.

According to a further embodiment, mixtures comprise as component II the Bacillus subtilis strain with NRRL Accession No. B-21661, a mutant thereof having all the identifying characteristics of the strain, or a metabolite produced by the strain that exhibits activity against plant pathogenic fungi.

The mixtures and compositions according to the invention are suitable as fungicides. They are distinguished by an outstanding effectiveness against a broad spectrum of phytopathogenic fungi, including soil-borne fungi, which derive especially from the classes of the Plasmodiophoromycetes, Peronosporomycetes (syn. Oomycetes), Chytridiomycetes, Zygomycetes, Ascomycetes, Basidiomycetes and Deuteromycetes (syn. Fungi imperfecti). Some are systemically effective and they can be used in crop protection as foliar fungicides, fungicides for seed dressing and soil fungicides. More-over, they are suitable for controlling harmful fungi, which inter alia occur in wood or roots of plants.

The mixtures and compositions according to the invention are particularly important in the control of a multitude of phytopathogenic fungi on various cultivated plants, such as cereals, e.g. wheat, rye, barley, triticale, oats or rice; beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf; natural rubber plants or ornamental and forestry plants, such as flowers, shrubs, broad-leaved trees or evergreens, e.g. conifers; and on the plant propagation material, such as seeds, and the crop material of these plants.

Preferably the inventive mixtures and compositions are used for controlling a multitude of fungi on field crops, such as potatoes sugar beets, tobacco, wheat, rye, barley, oats, rice, corn, cotton, soybeans, rape, legumes, sunflowers, coffee or sugar cane; fruits; vines; ornamentals; or vegetables, such as cucumbers, tomatoes, beans or squashes.

The term “plant propagation material” is to be understood to denote all the generative parts of the plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil. These young plants may also be protected before transplantation by a total or partial treatment by immersion or pouring.

Preferably, treatment of plant propagation materials with the inventive mixture of compound I and fungicidal component(s) II and compositions thereof, respectively, is used for controlling a multitude of fungi on cereals, such as wheat, rye, barley and oats; rice, corn, cotton and soybeans.

The term “cultivated plants” is to be understood as including plants which have been modified by breeding, mutagenesis or genetic engineering including but not limiting to agricultural biotech products on the market or in development (cf. http://www.bio.org/speeches/pubs/er/agri_products.asp). Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-transtional modification of protein(s), oligo- or polypeptides e.g. by glycosylation or polymer additions such as prenylated, acetylated or farnesylated moieties or PEG moieties.

The inventive mixtures and compositions are particularly suitable for controlling the following plant diseases:

Alternaria spp. (Alternaria leaf spot) on vegetables, rape (A. brassicola or brassicae), sugar beets (A. tenuis), fruits, rice, soybeans, potatoes (e.g. A. solani or A. alternata), tomatoes (e.g. A. solani or A. alternata) and wheat; Bipolaris and Drechslera spp. (teleomorph: Cochliobolus spp.), e.g. Southern leaf blight (D. maydis) or Northern leaf blight (B. zeicola) on corn, e.g. spot blotch (B. sorokiniana) on cereals and e.g. B. oryzae on rice and turfs; Blumeria (formerly Erysiphe) graminis (powdery mildew) on cereals (e.g. on wheat or barley); Botrytis cinerea (teleomorph: Botryotinia fuckeliana: grey mold) on fruits and berries (e.g. strawberries), vegetables (e.g. lettuce, carrots, celery and cabbages), rape, flowers, vines, forestry plants and wheat; Drechslera (syn. Helminthosporium, teleomorph: Pyrenophora) spp. on corn, cereals, such as barley (e.g. D. teres, net blotch) and wheat (e.g. D. tritici-repentis: tan spot), rice and turf; Esca (dieback, apoplexy) on vines; Erysiphe spp. (powdery mildew) on sugar beets (E. betae), vegetables (e.g. E. pisi), such as cucurbits (e.g. E. cichoracearum), cabbages, rape (e.g. E. cruciferarum); Fusarium (teleomorph: Gibberella) spp. (wilt, root or stem rot) on various plants, such as F. graminearum or F. culmorum (root rot, scab or head blight) on cereals (e.g. wheat or barley), F. oxysporum on tomatoes, F. solani on soybeans and F. verticillioides on corn; Gaeumannomyces graminis (take-all) on cereals (e.g. wheat or barley) and corn; Gibberella spp. on cereals (e.g. G. zeae) and rice (e.g. G. fujikuroi: Bakanae disease); Guignardia bidwellii (black rot) on vines; Microdochium (syn. Fusarium) nivale (pink snow mold) on cereals (e.g. wheat or barley); Monilinia spp., e.g. M. laxa, M. fructicola and M. fructigena (bloom and twig blight, brown rot) on stone fruits and other rosaceous plants; Mycosphaerella spp. on cereals, bananas, soft fruits and ground nuts, such as e.g. M. graminicola (anamorph: Septoria tritici, Septoria blotch) on wheat or M. fijiensis (black Sigatoka disease) on bananas; Peronospora spp. (downy mildew) on cabbage (e.g. P. brassicae), rape (e.g. P. parasitica), onions (e.g. P. destructor), tobacco (P. tabacina) and soybeans (e.g. P. manshurica); Phakopsora pachyrhizi and P. meibomiae (soybean rust) on soybeans; Phytophthora spp. (wilt, root, leaf, fruit and stem root) on various plants, such as paprika and cucurbits (e.g. P. capsici), soybeans (e.g. P. megasperma, syn. P. sojae), potatoes and tomatoes (e.g. P. infestans: late blight); Plasmopara spp., e.g. P. viticola (grapevine downy mildew) on vines; Puccinia spp. (rusts) on various plants, e.g. P. triticina (brown or leaf rust), P. striiformis (stripe or yellow rust), P. hordei (dwarf rust), P. graminis (stem or black rust) or P. recondita (brown or leaf rust) on cereals, such as e.g. wheat, barley or rye, and asparagus (e.g. P. asparagi); Pyrenophora (anamorph: Drechslera) tritici-repentis (tan spot) on wheat or P. teres (net blotch) on barley; Pyricularia spp., e.g. P. oryzae (teleomorph: Magnaporthe grisea, rice blast) on rice and P. grisea on turf and cereals; Pythium spp. (damping-off) on turf, rice, corn, wheat, cotton, rape, sunflowers, soybeans, sugar beets, vegetables and various other plants (e.g. P. ultimum or P. aphanidermatum); Rhizoctonia spp. on cotton, rice, potatoes, turf, corn, rape, potatoes, sugar beets, vegetables and various other plants, e.g. R. solani (root and stem rot) on soybeans, R. solani (sheath blight) on rice or R. cerealis (Rhizoctonia spring blight) on wheat or barley; Rhynchosporium secalis (scald) on barley, rye and triticale; Septoria spp. on various plants, e.g. S. glycines (brown spot) on soybeans, S. tritici (Septoria blotch) on wheat and S. (syn. Stagonospora) nodorum (Stagonospora blotch) on cereals; Uncinula (syn. Erysiphe) necator (powdery mildew, anamorph: Oidium tuckeri) on vines; Stagonospora spp. on cereals, e.g. S. nodorum (Stagonospora blotch, teleomorph: Leptosphaeria [syn. Phaeosphaeria] nodorum) on wheat; Venturia spp. (scab) on apples (e.g. V. inaequalis) and pears.

The mixtures and compositions thereof, respectively, are also suitable for controlling harmful fungi in the protection of stored products or harvest and in the protection of materials. The term “protection of materials” is to be understood to denote the protection of technical and non-living materials, such as adhesives, glues, wood, paper and paperboard, textiles, leather, paint dispersions, plastics, coiling lubricants, fiber or fabrics, against the infestation and destruction by harmful microorganisms, such as fungi and bacteria.

The mixtures and compositions thereof, respectively, may be used for improving the health of a plant. The invention also relates to a method for improving plant health by treating a plant, its propagation material and/or the locus where the plant is growing or is to grow with an effective amount of compounds I and compositions thereof, respectively.

The term “plant health” is to be understood to denote a condition of the plant and/or its products which is determined by several indicators alone or in combination with each other such as yield (e.g. increased biomass and/or increased content of valuable ingredients), plant vigor (e.g. improved plant growth and/or greener leaves (“greening effect”)), quality (e.g. improved content or composition of certain ingredients) and tolerance to abiotic and/or biotic stress. The above identified indicators for the health condition of a plant may be interdependent or may result from each other.

The compounds I and/or fungicidal components II can be present in different crystal modifications whose biological activity may differ. They are likewise subject matter of the present invention.

The mixtures are employed as such or in form of compositions by treating the fungi or the plants, plant propagation materials, such as seeds, soil, surfaces, materials or rooms to be protected from fungal attack with a fungicidally effective amount of the active substances. The application can be carried out both before and after the infection of the plants, plant propagation materials, such as seeds, soil, surfaces, materials or rooms by the fungi.

The invention also relates to agrochemical compositions comprising a solvent or solid carrier and at least one compound I and to the use for controlling harmful fungi.

The compound I and fungicidal components, their N-oxides and salts can be converted into customary types of agrochemical compositions, e.g. solutions, emulsions, suspensions, dusts, powders, pastes and granules. The composition type depends on the particular intended purpose; in each case, it should ensure a fine and uniform distribution of the compound according to the invention.

Examples for composition types are suspensions (SC, OD, FS), emulsifiable concentrates (EC), emulsions (EW, EO, ES), pastes, pastilles, wettable powders or dusts (WP, SP, SS, WS, DP, DS) or granules (GR, FG, GG, MG), which can be water-soluble or wettable, as well as gel formulations for the treatment of plant propagation materials such as seeds (GF).

Usually the composition types (e.g. SC, OD, FS, EC, WG, SG, WP, SP, SS, WS, GF) are employed diluted. Composition types such as DP, DS, GR, FG, GG and MG are usually used undiluted.

The compositions are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, S. 8-57 and ff. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation technology (Wiley VCH Verlag, Weinheim, 2001).

The agrochemical compositions may also comprise auxiliaries which are customary in agrochemical compositions. The auxiliaries used depend on the particular application form and active substance, respectively.

Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e.g. for seed treatment formulations).

Powders, materials for spreading and dusts can be prepared by mixing or concomitantly grinding the compounds I and, if appropriate, further active substances, with at least one solid carrier.

Granules, e.g. coated granules, impregnated granules and homogeneous granules, can be prepared by binding the active substances to solid carriers.

The agrochemical compositions generally comprise between 0.01 and 95%, preferably between 0.1 and 90%, most preferably between 0.5 and 90%, by weight of active substance. The active substances are employed in a purity of from 90% to 100%, preferably from 95% to 100% (according to NMR spectrum).

Water-soluble concentrates (LS), flowable concentrates (FS), powders for dry treatment (DS), water-dispersible powders for slurry treatment (WS), water-soluble powders (SS), emulsions (ES) emulsifiable concentrates (EC) and gels (GF) are usually employed for the purposes of treatment of plant propagation materials, particularly seeds. These compositions can be applied to plant propagation materials, particularly seeds, diluted or undiluted. The compositions in question give, after two-to-tenfold dilution, active substance concentrations of from 0.01 to 60% by weight, preferably from 0.1 to 40% by weight, in the ready-to-use preparations.

In a preferred embodiment, a suspension-type (FS) composition is used for seed treatment. Typically, a FS composition may comprise 1-800 g/l of active substance, 1-200 g/l Surfactant, 0 to 200 g/l antifreezing agent, 0 to 400 g/l of binder, 0 to 200 g/l of a pigment and up to 1 liter of a solvent, preferably water.

Aqueous application forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active substance concentrations in the ready-to-use preparations can be varied within relatively wide ranges. In general, they are from 0.0001 to 10%, preferably from 0.001 to 1% by weight of active substance.

The active substances may also be used successfully in the ultra-low-volume process (ULV), it being possible to apply compositions comprising over 95% by weight of active substance, or even to apply the active substance without additives.

When employed in plant protection, the amounts of active substances applied are, depending on the kind of effect desired, from 0.001 to 2 kg per ha, preferably from 0.005 to 2 kg per ha, more preferably from 0.05 to 0.9 kg per ha, in particular from 0.1 to 0.75 kg per ha.

In treatment of plant propagation materials such as seeds, e.g. by dusting, coating or drenching seed, amounts of active substance of from 0.1 to 10,000 g, preferably from 1 to 1000 g, more preferably from 1 to 100 g and most preferably from 5 to 100 g, per 100 kilogram of plant propagation material (preferably seed) are generally required.

When used in the protection of materials or stored products, the amount of active substance applied depends on the kind of application area and on the desired effect. Amounts customarily applied in the protection of materials are, e.g., 0.001 g to 2 kg, preferably 0.005 g to 1 kg, of active substance per cubic meter of treated material.

Various types of oils, wetters, adjuvants, herbicides, bactericides, other fungicides and/or pesticides may be added to the active substances or the compositions comprising them, if appropriate not until immediately prior to use (tank mix). These agents can be admixed with the compositions according to the invention in a weight ratio of 1:100 to 100:1, preferably 1:10 to 10:1.

The compositions according to the invention can, in the use form as fungicides, also be present together with other active substances, e.g. with herbicides, insecticides, growth regulators, fungicides or else with fertilizers, as pre-mix or, if appropriate, not until immeadiately prior to use (tank mix).

According to this invention, applying compound I together with a fungicidal component II is to be understood to denote, that a compound I and at least one fungicidal component II occur simultaneously at the site of action (i.e. the harmful fungi to be controlled or their habitats such as infected plants, plant propagation materials, particularly seeds, surfaces, materials or the soil as well as plants, plant propagation materials, particularly seeds, soil, surfaces, materials or rooms to be protected from fungal attack) in an effective amount. This can be obtained by applying compound I and fungicidal component II simultaneously, either jointly (e.g. as tank-mix) or separately, or in succession, wherein the time interval between the individual applications is selected to ensure that the active substance applied first still occurs at the site of action in a sufficient amount at the time of application of the further active substance(s). The order of application is not essential for working of the present invention.

In the inventive mixtures and compositions thereof, i.e. compositions according to the invention comprising one compound I and one fungicidal component II, the weight ratio of compound I and component II generally depends from the properties of the active substances used, usually it is in the range of from 1:100 to 100:1, regularly in the range of from 1:50 to 50:1, preferably in the range of from 1:20 to 20:1, more preferably in the range of from 1:10 to 10:1 and in particular in the range of from 1:3 to 3:1.

In ternary mixtures, i.e. compositions according to the invention comprising one compound I (component 1) and one fungicidal component II (component 2), and a further active substance (component 3), e.g. an active substance selected from groups A) to F), the weight ratio of component 1 and component 2 depends from the properties of the active substances used, usually it is in the range of from 1:100 to 100:1, regularly in the range of from 1:50 to 50:1, preferably in the range of from 1:20 to 20:1, more preferably in the range of from 1:10 to 10:1 and in particular in the range of from 1:3 to 3:1, and the weight ratio of component 1 and component 3 usually it is in the range of from 1:100 to 100:1, regularly in the range of from 1:50 to 50:1, preferably in the range of from 1:20 to 20:1, more preferably in the range of from 1:10 to 10:1 and in particular in the range of from 1:3 to 3:1.

In the mixtures and compositions, the compound I/fungicidal component II ratio is advantageously chosen so as to produce a synergistic effect.

The term “synergstic effect” is understood to refer in particular to that defined by Colby's formula (Colby, S. R., “Calculating synergistic and antagonistic responses of herbicide combinations”, Weeds, 15, pp. 20-22, 1967).

The term “synergistic effect” is also understood to refer to that defined by application of the Tammes method, (Tammes, P. M. L., “Isoboles, a graphic representation of synergism in pesticides”, Netherl. J. Plant Pathol. 70, 1964).

The components can be used individually or already partially or completely mixed with one another to prepare the composition according to the invention. It is also possible for them to be packaged and used further as combination composition such as a kit of parts.

In one embodiment of the invention, the kits may include one or more, including all, components that may be used to prepare a subject agrochemical composition. E.g., kits may include one or more fungicide component(s) and/or an adjuvant component and/or a insecticide component and/or a growth regulator component and/or a herbicde. One or more of the components may already be combined together or pre-formulated. In those embodiments where more than two components are provided in a kit, the components may already be combined together and as such are packaged in a single container such as a vial, bottle, can, pouch, bag or canister. In other embodiments, two or more components of a kit may be packaged separately, i.e., not pre-formulated. As such, kits may include one or more separate containers such as vials, cans, bottles, pouches, bags or canisters, each container containing a separate component for an agrochemical composition. In both forms, a component of the kit may be applied separately from or together with the further components or as a component of a combination composition according to the invention for preparing the composition according to the invention.

Mixing the binary mixtures or the compositions comprising them in the use form as fungicides with other fungicides results in many cases in an expansion of the fungicidal spectrum of activity being obtained or in a prevention of fungicide resistance development. Furthermore, in many cases, synergistic effects are obtained.

The following list of active substances, in conjunction with which the compounds according to the invention can be used, is intended to illustrate the possible combinations but does not limit them:

A) strobilurins
azoxystrobin, coumethoxystrobin, coumoxystrobin, dimoxystrobin, enestroburin, fluoxastrobin, kresoxim-methyl, metominostrobin, orysastrobin, picoxystrobin, pyrclostrobin, pyrametostrobin, pyraoxystrobin, pyribencarb, trifloxystrobin, 2-[2-(2,5-dimethyl-phenoxymethyl)-phenyl]-3-methoxy-acrylic acid methyl ester and 2-(2-(3-(2,6-dichlorophenyl)-1-methyl-allylideneaminooxymethyl)-phenyl)-2-methoxyimino-N-methyl-acetamide;
   B) carboxamides
carboxanilides: benalaxyl, benalaxyl-M, benodanil, bixafen, boscalid, carboxin, fenfuram, fenhexamid, flutolanil, fluxapyroxad, furametpyr, isopyrazam, isotianil, kiralaxyl, mepronil, metalaxyl, metalaxyl-M (mefenoxam), ofurace, oxadixyl, oxycarboxin, penflufen, penthiopyrad, sedaxane, tecloftalam, thifluzamide, tiadinil, 2-amino-4-methyl-thiazole-5-carboxanilide, N-(4′-trifluoromethylthiobiphenyl-2-yl)-3-difluoromethyl-1-methyl-1H-pyrazole-4-carboxamide and N-(2-(1,3,3-trimethyl-butyl)-phenyl)-1,3-dimethyl-5-fluoro-1H-pyrazole-4-carboxamide;
carboxylic morpholides: dimethomorph, flumorph, pyrimorph;
benzoic acid amides: flumetover, fluopicolide, fluopyram, zoxamide;
other carboxamides: carpropamid, dicyclomet, mandiproamid, oxytetracyclin, silthiofam and N-(6-methoxy-pyridin-3-yl)cyclopropanecarboxylic acid amide;
   C) azoles
triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole;
imidazoles: cyazofamid, imazalil, pefurazoate, prochloraz, triflumizol;
benzimidazoles: benomyl, carbendazim, fuberidazole, thiabendazole;
others: ethaboxam, etridiazole, hymexazole and 2-(4-chloro-phenyl)-N-[4-(3,4-dimethoxy-phenyl)-isoxazol-5-yl]-2-prop-2-ynyloxy-acetamide;
   D) heterocyclic compounds
pyridines: fluazinam, pyrifenox, 3-[5-(4-chloro-phenyl)-2,3-dimethyl-isoxazolidin-3-yl]-pyridine, 345-(4-methyl-phenyl)-2,3-dimethyl-isoxazolidin-3-yl]-pyridine;
pyrimidines: bupirimate, cyprodinil, diflumetorim, fenarimol, ferimzone, mepanipyrim, nitrapyrin, nuarimol, pyrimethanil;
piperazines: triforine;
pyrroles: fenpiclonil, fludioxonil;
morpholines: aldimorph, dodemorph, dodemorph-acetate, fenpropimorph, tridemorph;
piperidines: fenpropidin;
dicarboximides: fluoroimid, iprodione, procymidone, vinclozolin;
non-aromatic 5-membered heterocycles: famoxadone, fenamidone, flutianil, octhilinone, probenazole, 5-amino-2-isopropyl-3-oxo-4-ortho-tolyl-2,3-dihydro-pyrazole-1-carbothioic acid S-allyl ester;
others: acibenzolar-S-methyl, ametoctradin, amisulbrom, anilazin, blasticidin-S, captafol, captan, chinomethionat, dazomet, debacarb, diclomezine, difenzoquat, difenzoquat-methylsulfate, fenoxanil, Folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxy-pyrimidin-2-yl)-2-methyl-1H-benzoimidazole and 5-chloro-7-(4-methylpiperidin-1-yl)-6-(2,4,6-trifluorophenyl)-[1,2,4]triazolo-[1,5-a]pyrimidine;
   E) carbamates
thio- and dithiocarbamates: ferbam, mancozeb, maneb, metam, methasulphocarb, metiram, propineb, thiram, zineb, ziram;
carbamates: benthiavalicarb, diethofencarb, iprovalicarb, propamocarb, propamocarb hydrochlorid, valifenalate and N-(1-(1-(4-cyano-phenyl)ethanesulfonyl)-but-2-yl) carbamic acid-(4-fluorophenyl) ester;
   F) other active substances
guanidines: guanidine, dodine, dodine free base, guazatine, guazatine-acetate, iminoctadine, iminoctadine-triacetate, iminoctadine-tris(albesilate);
antibiotics: kasugamycin, kasugamycin hydrochloride-hydrate, streptomycin, poly-oxine, validamycin A;
nitrophenyl derivates: binapacryl, dicloran, dinobuton, dinocap, nitrothal-isopropyl, tecnazen,
organometal compounds: fentin salts, such as fentin-acetate, fentin chloride or fentin hydroxide;
sulfur-containing heterocyclyl compounds: dithianon, isoprothiolane;
organophosphorus compounds: edifenphos, fosetyl, fosetyl-aluminum, iprobenfos, phosphorous acid and its salts, pyrazophos, tolclofos-methyl;
organochlorine compounds: chlorothalonil, dichlofluanid, dichlorophen, flusulfamide, hexachlorobenzene, pencycuron, pentachlorphenole and its salts, phthalide, quinto-zene, thiophanate-methyl, tolylfluanid, N-(4-chloro-2-nitro-phenyl)-N-ethyl-4-methyl-benzenesulfonamide;
inorganic active substances: Bordeaux mixture, copper acetate, copper hydroxide, copper oxychloride, basic copper sulfate, sulfur;
antifungal biocontrol agents, plant bioactivators: Ampelomyces quisqualis (e.g. AQ 10® from Intrachem Bio GmbH & Co. KG, Germany), Aspergillus flavus (e.g. AFLA-GUARD® from Syngenta, CH), Aureobasidium pullulans (e.g. BOTECTOR® from bio-ferm GmbH, Germany), Bacillus pumilus (e.g. NRRL Accession No. B-30087 in SONATA® and BALLAD® Plus from AgraQuest Inc., USA), Bacillus subtilis (e.g. isolate NRRL-Nr. B-21661 in RHAPSODY®, SERENADE® MAX and SERENADE® ASO from AgraQuest Inc., USA), Bacillus subtilis var. amyloliquefaciens FZB24 (e.g. TAEGRO® from Novozyme Biologicals, Inc., USA), Candida oleophila I-82 (e.g. ASPIRE® from Ecogen Inc., USA), Candida saitoana (e.g. BIOCURE® (in mixture with lysozyme) and BIOCOAT® from Micro Flo Company, USA (BASF SE) and Arysta), Chitosan (e.g. ARMOUR-ZEN from BotriZen Ltd., NZ), Clonostachys rosea f. catenulata, also named Gliocladium catenulatum (e.g. isolate J1446: PRESTOP® from Verdera, Finland), Coniothyrium minitans (e.g. CONTANS® from Prophyta, Germany), Cryphonectria parasitica (e.g. Endothia parasitica from CNICM, France), Cryptococcus albidus (e.g. YIELD PLUS® from Anchor Bio-Technologies, South Africa), Fusarium oxysporum (e.g. BIOFOX® from S.I.A.P.A., Italy, FUSACLEAN® from Natural Plant Protection, France), Metschnikowia fructicola (e.g. SHEMER® from Agrogreen, Israel), Microdochium dimerum (e.g. ANTIBOT® from Agrauxine, France), Phlebiopsis gigantea (e.g. ROTSOP® from Verdera, Finland), Pseudozyma flocculosa (e.g. SPORODEX® from Plant Products Co. Ltd., Canada), Pythium oligandrum DV74 (e.g. POLYVERSUM® from Remeslo SSRO, Biopreparaty, Czech Rep.), Reynoutria sachlinensis (e.g. REGALIA® from Marrone BioInnovations, USA), Talaromyces flavus V117b (e.g. PROTUS® from Prophyta, Germany), Trichoderma asperellum SKT-1 (e.g. ECO-HOPE® from Kumiai Chemical Industry Co., Ltd., Japan), T. atroviride LC52 (e.g. SENTINEL® from Agrimm Technologies Ltd, NZ), T. harzianum T-22 (e.g. PLANTSHIELD® der Firma BioWorks Inc., USA), T. harzianum TH 35 (e.g. ROOT PRO® from Mycontrol Ltd., Israel), T. harzianum T-39 (e.g. TRICHODEX® and TRICHODERMA 2000® from Mycontrol Ltd., Israel and Makhte-shim Ltd., Israel), T. harzianum and T. viride (e.g. TRICHOPEL from Agrimm Technologies Ltd, NZ), T. harzianum ICC012 and T. viride ICC080 (e.g. REMEDIER®WP from Isagro Ricerca, Italy), T. polysporum and T. harzianum (e.g. BINAB® from BINAB Bio-Innovation AB, Sweden), T. stromaticum (e.g. TRICOVAB® from C.E.P.L.A.C., Brazil), T. virens GL-21 (e.g. SOILGARD® from Certis LLC, USA), T. viride (e.g. TRIECO® from Ecosense Labs. (India) Pvt. Ltd., Indien, BIO-CURE® F from T. Stanes & Co. Ltd., Indien), T. viride TV1 (e.g. T. viride TV1 from Agribiotec srl, Italy), Ulocladium oudemansii HRU3 (e.g. BOTRY-ZEN® from Botry-Zen Ltd, NZ);
others: biphenyl, bronopol, cyflufenamid, cymoxanil, diphenylamin, metrafenone, pyriofenone, mildiomycin, oxin-copper, prohexadione-calcium, spiroxamine, tebufloquin, tolylfluanid, N-(cyclopropylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)-phenyl)-N-ethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, methoxy-acetic acid 6-tert-butyl-8-fluoro-2,3-dimethyl-quinolin-4-yl ester and N-Methyl-2-{1-[(5-methyl-3-trifluoromethyl-1H-pyrazol-1-yl)-acetyl]-piperidin-4-yl}-N-[(1R)-1,2,3,4-tetrahydro-naphthalen-1-yl]-4-thiazolecarboxamide.
   G) growth regulators
abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6-benzyladenine, paclobutrazol, prohexadione (prohexadione-calcium), prohydrojasmon, thidiazuron, triapenthenol, tributyl phosphorotrithioate, 2,3,5-tri-iodobenzoic acid, trinexapac-ethyl and uniconazole;
   H) herbicides
acetamides: acetochlor, alachlor, butachlor, dimethachlor, dimethenamid, flufena-cet, mefenacet, metolachlor, metazachlor, napropamide, naproanilide, pethoxamid, pretilachlor, propachlor, thenylchlor;
amino acid derivatives: bilanafos, glyphosate, glufosinate, sulfosate;
aryloxyphenoxypropionates: clodinafop, cyhalofop-butyl, fenoxaprop, fluazifop, ha-loxyfop, metamifop, propaquizafop, quizalofop, quizalofop-P-tefuryl;
Bipyridyls: diquat, paraquat;
(thio)carbamates: asulam, butylate, carbetamide, desmedipham, dimepiperate, eptam (EPIC), esprocarb, molinate, orbencarb, phenmedipham, prosulfocarb, pyributicarb, thiobencarb, triallate;
cyclohexanediones: butroxydim, clethodim, cycloxydim, profoxydim, sethoxydim, tepraloxydim, tralkoxydim;
dinitroanilines: benfluralin, ethalfluralin, oryzalin, pendimethalin, prodiamine, trifluralin;
diphenyl ethers: acifluorfen, aclonifen, bifenox, diclofop, ethoxyfen, fomesafen, lactofen, oxyfluorfen;
hydroxybenzonitriles: bomoxynil, dichlobenil, ioxynil;
imidazolinones: imazamethabenz, imazamox, imazapic, imazapyr, imazaquin, imazethapyr;
phenoxy acetic acids: clomeprop, 2,4-dichlorophenoxyacetic acid (2,4-D), 2,4-DB, dichlorprop, MCPA, MCPA-thioethyl, MCPB, Mecoprop;
pyrazines: chloridazon, flufenpyr-ethyl, fluthiacet, norflurazon, pyridate;
pyridines: aminopyralid, clopyralid, diflufenican, dithiopyr, fluridone, fluroxypyr, picloram, picolinafen, thiazopyr;
sulfonyl ureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metazosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propyl-imidazo[1,2-b]pyridazin-3-yl)sulfonyl)-3-(4,6-dimethoxy-pyrimidin-2-yl)urea;
triazines: ametryn, atrazine, cyanazine, dimethametryn, ethiozin, hexazinone, metamitron, metribuzin, prometryn, simazine, terbuthylazine, terbutryn, triaziflam;
ureas: chlorotoluron, daimuron, diuron, fluometuron, isoproturon, linuron, methabenzthiazuron, tebuthiuron;
other acetolactate synthase inhibitors: bispyribac-sodium, cloransulam-methyl, diclosulam, florasulam, flucarbazone, flumetsulam, metosulam, ortho-sulfamuron, penoxsulam, propoxycarbazone, pyribambenz-propyl, pyribenzoxim, pyriftalid, pyriminobac-methyl, pyrimisulfan, pyrithiobac, pyroxasulfone, pyroxsulam;
others: amicarbazone, aminotriazole, anilofos, beflubutamid, benazolin, bencarbazone, benfluresate, benzofenap, bentazone, benzobicyclon, bicyclopyrone, bromacil, bromobutide, butafenacil, butamifos, cafenstrole, carfentrazone, cinidon-ethlyl, chlorthal, cinmethylin, clomazone, cumyluron, cyprosulfamide, dicamba, difenzoquat, diflufenzopyr, Drechslera monoceras, endothal, ethofumesate, etobenzanid, fenoxasulfone, fentrazamide, flumiclorac-pentyl, flumioxazin, flupoxam, flurochloridone, flurtamone, indanofan, isoxaben, isoxaflutole, lenacil, propanil, propyzamide, quinclorac, quinmerac, mesotrione, methyl arsonic acid, naptalam, oxadiargyl, oxadiazon, oxaziclomefone, pentoxazone, pinoxaden, pyraclonil, pyraflufen-ethyl, pyrasulfotole, pyrazoxyfen, pyrazolynate, quinoclamine, saflufenacil, sulcotrione, sulfentrazone, terbacil, tefuryltrione, tembotrione, thiencarbazone, topramezone, (3-[2-chloro-4-fluoro-5-(3-methyl-2,6-dioxo-4-trifluoromethyl-3,6-dihydro-2H-pyrimidin-1-yl)-phenoxy]-pyridin-2-yloxy)-acetic acid ethyl ester, 6-amino-5-chloro-2-cyclopropyl-pyrimidine-4-carboxylic acid methyl ester, 6-chloro-3-(2-cyclopropyl-6-methyl-phenoxy)-pyridazin-4-ol, 4-amino-3-chloro-6-(4-chloro-phenyl)-5-fluoro-pyridine-2-carboxylic acid, 4-amino-3-chloro-6-(4-chloro-2-fluoro-3-methoxy-phenyl)-pyridine-2-carboxylic acid methyl ester, and 4-amino-3-chloro-6-(4-chloro-3-dimethylamino-2-fluoro-phenyl)-pyridine-2-carboxylic acid methyl ester.
   I) insecticides
organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;
insect growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid bio-synthesis inhibitors: spirodiclofen, spiromesifen, spirotetramat;
nicotinic receptor agonists/antagonists compounds: clothianidin, dinotefuran, imidacloprid, thiamethoxam, nitenpyram, acetamiprid, thiacloprid, 1-(2-chloro-thiazol-5-ylmethyl)-2-nitrimino-3,5-dimethyl-[1,3,5]triazinane;
GABA antagonist compounds: endosulfan, ethiprole, fipronil, vaniliprole, pyrafluprole, pyriprole, 5-amino-1-(2,6-dichloro-4-methyl-phenyl)-4-sulfinamoyl-1H-pyrazole-3-carbothioic acid amide;
macrocyclic lactone insecticides: abamectin, emamectin, milbemectin, lepimectin, spinosad, spinetoram;
mitochondrial electron transport inhibitor (METI) I acaricides: fenazaquin, pyridaben, tebufenpyrad, tolfenpyrad, flufenerim;
METI II and III compounds: acequinocyl, fluacyprim, hydramethylnon;
Uncouplers: chlorfenapyr;
oxidative phosphorylation inhibitors: cyhexatin, diafenthiuron, fenbutatin oxide, propargite;
moulting disruptor compounds: cryomazine;
mixed function oxidase inhibitors: piperonyl butoxide;
sodium channel blockers: indoxacarb, metaflumizone;
others: benclothiaz, bifenazate, cartap, flonicamid, pyridalyl, pymetrozine, sulfur, thiocyclam, flubendiamide, chlorantraniliprole, cyazypyr (HGW86), cyenopyrafen, flupyrazofos, cyflumetofen, amidoflumet, imicyafos, bistrifluron, and pyrifluquinazon.

The active substances referred to as component 2, their preparation and their activity against harmful fungi is known (cf.: http://www.alanwood.net/pesticides/); these substances are commercially available. The compounds described by IUPAC nomenclature, their preparation and their fungicidal activity are also known (cf. Can. J. Plant Sci. 48(6), 587-94, 1968; EP-A 141 317; EP-A 152 031; EP-A 226 917; EP-A 243 970; EP-A 256 503; EP-A 428 941; EP-A 532 022; EP-A 1 028 125; EP-A 1 035 122; EP-A 1 201 648; EP-A 1 122 244, JP 2002316902; DE 19650197; DE 10021412; DE 102005009458; U.S. Pat. No. 3,296,272; U.S. Pat. No. 3,325,503; WO 98/46608; WO 99/14187; WO 99/24413; WO 99/27783; WO 00/29404; WO 00/46148; WO 00/65913; WO 01/54501; WO 01/56358; WO 02/22583; WO 02/40431; WO 03/10149; WO 03/11853; WO 03/14103; WO 03/16286; WO 03/53145; WO 03/61388; WO 03/66609; WO 03/74491; WO 04/49804; WO 04/83193; WO 05/120234; WO 05/123689; WO 05/123690; WO 05/63721; WO 05/87772; WO 05/87773; WO 06/15866; WO 06/87325; WO 06/87343; WO 07/82098; WO 07/90624).

The fungicidal action of the mixtures and compositions thereof can be shown by the tests described below.

The stock solution were prepared: a mixture of acetone and/or dimethylsulfoxide and the wetting agent/emulsifier Wettol, which is based on ethoxylated alkylphenoles, in a relation (volume) solvent-emulsifier of 99 to 1 was added to 25 mg of the compound to give a total of 10 ml. Water was then added to total volume of 100 ml.
This stock solution was diluted with the described solvent-emulsifier-water mixture to the given concentration.

The visually determined percentages of infected leaf areas are converted into efficacies in % of the untreated control.

The efficacy (E) is calculated as follows using Abbot's formula:

E=(1−α/β)·100

α corresponds to the fungicidal infection of the treated plants in % and
β corresponds to the fungicidal infection of the untreated (control) plants in %

An efficacy of 0 means that the infection level of the treated plants corresponds to that of the untreated control plants; an efficacy of 100 means that the treated plants were not infected.

The expected efficacies of active compound combinations were determined using Colby's formula (Colby, S. R. “Calculating synergistic and antagonistic responses of herbicide combinations”, Weeds, 15, pp. 20-22, 1967) and compared with the observed efficacies.

Colby's formula: E=x+y−x·y/100

E expected efficacy, expressed in % of the untreated control, when using the mixture of the active compounds A and B at the concentrations a and b
x efficacy, expressed in % of the untreated control, when using the active compound A at the concentration a
y efficacy, expressed in % of the untreated control, when using the active compound B at the concentration b.

### Green House

### EXAMPLE-1

### Fungicidal Control of Grape Downy Mildew Caused by Plasmopara viticola

Grape cuttings were grown in pots to the 4 to 5 leaf stage. These plants were sprayed to run-off with an aqueous suspension, containing the concentration of active ingredient or their mixture mentioned in the table below. The plants were allowed to air-dry. The next day they were inoculated with an aqueous spore suspension of Plasmopara viticola by spraying it at the lower leaf-side. Then the trial plants were immediately transferred for 24 h to a humid chamber with 22-24° C. and a relative humidity close to 100%. For a period of 5 days, cultivation followed in a greenhouse at 20-25° C. and a relative humidity about 50-80%. To stimulate the outbreak of the disease symptoms, the plants were transferred to a humid chamber again for 24 hours. Then the extent of fungal attack on the lower leaf surface was visually assessed as % diseased leaf area.

| | | | | Calculated |
|---|---|---|---|---|
| | | | | efficacy |
| | Concentration | | Observed | according to |
| Active compound/active mixture | (ppm) | Mixture | efficacy | Colby (%) |
| Untreated control | | | 90% disease | |
| 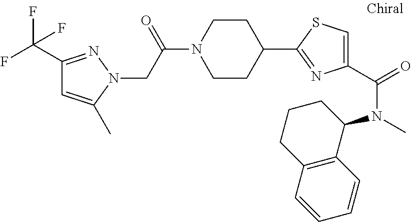 | 0.063 | | 67 | |
| 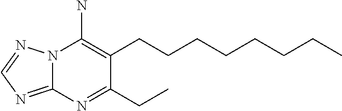 | 0.016 | | 11 | |
| 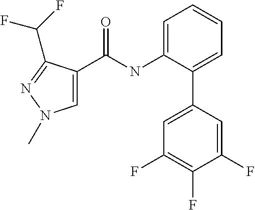 | 0.016 | | 0 | |
| 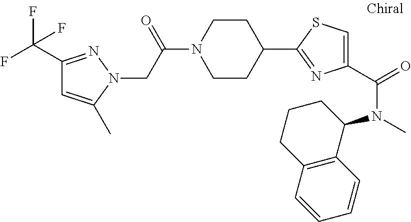 | 0.063 | 4:1 | 89 | 70 |
| 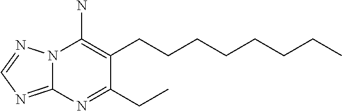 | 0.016 | | | |
| 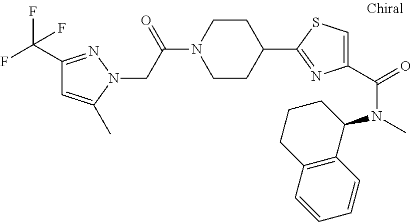 | 0.063 | 4:1 | 94 | 67 |
| 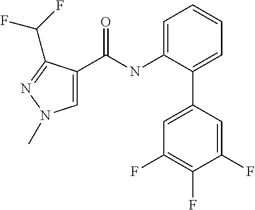 | 0.016 | | | |

### Microtest

The active compounds were formulated separately as a stock solution having a concentration of 10000 ppm in dimethyl sulfoxide.

SERENADE® is a microbial biological control agent based on Bacillus subtilis which protects against fungal and bacterial plant pathogens. Bacillus subtilis strain AQ 713 is a naturally occurring widespread bacterium that can be used to control plant diseases including blight, scab, gray mold, and several types of mildew. Suitable formulations of the Bacillus subtilis strain with NRRL Accession No. B-21661 are commercially available under the tradenames SERENADE®, SERENADE® MAX and SERENADE® ASO from AgraQuest, Inc., 1540 Drew Avenue, Davis, Calif. 95618, U.S.A.

### EXAMPLE-2

### Activity Against the Late Blight Pathogen Phytophthora infestans

The stock solutions were mixed according to the ratio, pipetted onto a micro titer plate (MTP) and diluted with water to the stated concentrations. A spore suspension of Phytophtora infestans containing a pea juice-based aqueous nutrient medium was then added. The plates were placed in a water vapor-saturated chamber at a temperature of 18° C. Using an absorption photometer, the MTPs were measured at 405 nm 7 days after the inoculation. The measured parameters were compared to the growth of the active compound-free control variant (100%) and the fungus-free and active compound-free blank value to determine the relative growth in % of the pathogens in the respective active compounds. These percentages were converted into efficacies.

| | | | | Calculated |
|---|---|---|---|---|
| | | | | efficacy |
| | Concentration | | Observed | according |
| Active compound/active mixture | (ppm) | Mixture | efficacy | to Colby (%) |
| 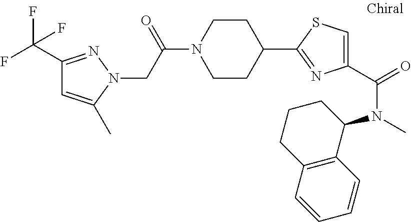 | 0.00025 | — | 0 | |
| Serenade | 0.001 | — | 7 | |
| 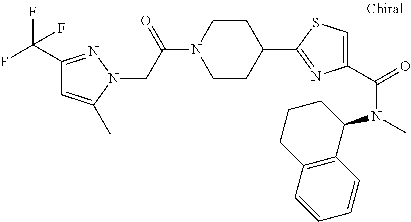 | 0.00025 | 1:4 | 29 | 7 |
| Serenade | 0.001 | | | |

### EXAMPLE-3

### Activity Against Rice Blast Pyricularia oryzae in the Microtiterplate Test

The stock solutions were mixed according to the ratio, pipetted onto a micro titer plate (MTP) and diluted with water to the stated concentrations. A spore suspension of Pyricularia oryzae in an aqueous biomalt solution was then added. The plates were placed in a water vapor-saturated chamber at a temperature of 18° C. Using an absorption photometer, the MTPs were measured at 405 nm 7 days after the inoculation.

The measured parameters were compared to the growth of the active compound-free control variant (100%) and the fungus-free and active compound-free blank value to determine the relative growth in % of the pathogens in the respective active compounds. These percentages were converted into efficacies.

| | | | | Calculated |
|---|---|---|---|---|
| | Concentration | | Observed | efficacy according |
| Active compound/active mixture | (ppm) | Mixture | efficacy | to Colby (%) |
| 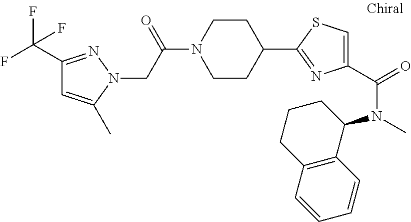 | 63 0.063 | — — | 28 1 | |
| 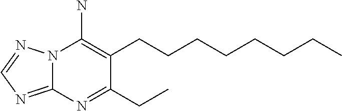 | 4 | — | 10 | |
| Serenade | 0.001 | — | 7 | |
| 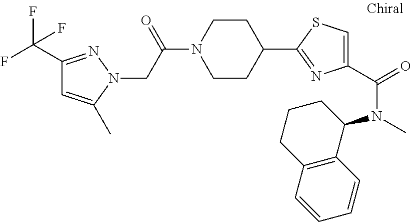 | 63 | 16:1 | 61 | 35 |
| 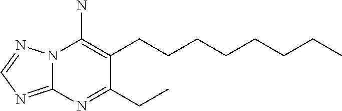 | 4 | | | |
| 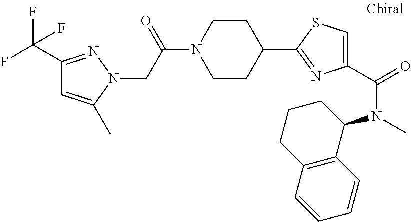 | 0.063 | 63:1 | 60 | 7 |
| Serenade | 0.001 | | | |

1-15. (canceled)

16. A mixture, comprising as active compounds
1) at least one compound of the formula (I) 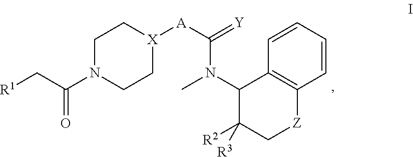
where:
R¹ is 1H-pyrazol-1-yl or phenyl, wherein the two aforementioned radicals are unsubstituted or carry 1 or 2 identical or different substituents R^{a};
R^{a} is halogen, CH₃, CH₂CH₅ or CF₃;
X is CH or N;
Y is O or S;
A is a 5-membered heteroarenediyl, wherein the ring member atoms include, besides carbon atoms, 1 sulfur atom and 1 nitrogen atom, or 1 oxygen atom and 1 nitrogen atom, or 2 or 3 nitrogen atoms;
Z is a divalent radical selected from the group consisting of —CH₂—, —CHOH— and ═C═O;
R², R³ independently of each other are selected from the group consisting of hydrogen and CH₃;
or the N-oxide or an agriculturally acceptable salt of the compound of the formula (I);
and
2) at least one fungicidal component II selected from groups A′) to C′):
A′) a carboxanilide selected from the group consisting of isopyrazam and 3-difluoromethyl-1-methyl-1H-pyrazole-4-carboxylic acid (3′,4′,5′-trifluorobiphenyl-2-yl)-amide;
B′) 5-ethyl-6-octyl-[1,2,4]-triazolo[1,5-a]pyrimidine-7-ylamine; and
C′) a fungicidal strain selected from the group consisting of Bacillus subtilis strain AQ713 with NRRL Accession No. B-21661, the Bacillus pumilus strain with NRRL
Accession No. B-30087, and mutants or variants of the aforementioned Bacillus strains having all the identifying characteristics of the respective strain, or a culture broth or a supernatant obtained from a culture of the aforementioned Bacillus strains;
or a metabolite produced by an aforementioned Bacillus strain that exhibits activity against plant pathogenic fungi;
in a synergistically effective amount.

17. The mixture according to claim 16, comprising at least one compound (I), wherein X is CH.

18. The mixture according to claim 16, comprising at least one compound (I), wherein R¹ is 1H-pyrazol-1-yl, which pyrazolyl carries 1 or 2 identical or different substituents R^{a}.

19. The mixture according to claim 16 comprising at least one compound (I), wherein A is thiazol-2,4-diyl, wherein the carbon atom in position 2 is bound to the variable X and the carbon atom in position 4 is bound to the group C═Y.

20. The mixture according to claim 16, comprising at least one compound (I), wherein Z is the divalent radical —CH₂— and wherein R² and R³ are both hydrogen.

21. The mixture according to claim 16, wherein compound I is selected from the group consisting of:
2-[1-[(2,5-dimethylphenyl)acetyl]-4-piperidinyl]-N-methyl-N-[(1R)-1,2,3,4-tetrahydro-1-naphthalenyl]-4-thiazolecarboxamide,
2-[1-[(2,5-dichlorophenyl)acetyl]-4-piperidinyl]-N-methyl-N-[(1R)-1,2,3,4-tetrahydro-1-naphthalenyl]-4-thiazolecarboxamide,
N-methyl-2-[1-[[5-methyl-3-(trifluoromethyl)-1H-pyrazol-1-yl]acetyl]-4-piperidinyl]-N-[(1R)-1,2,3,4-tetrahydro-1-naphthalenyl]-4-thiazolecarboxamide,
N-[(1R)-2,3-dihydro-1H-inden-1-yl]-N-methyl-2-[1-[[5-methyl-3-(trifluoromethyl)-1H-pyrazol-1-yl]acetyl]-4-piperidinyl]-4-thiazolecarboxamide,
N-methyl-2-[1-[[5-methyl-3-(trifluoromethyl)-1H-pyrazol-1-yl]acetyl]-4-piperidinyl]-N-[(1R)-1,2,3,4-tetrahydro-1-naphthalenyl]-4-thiazolecarbothioamide,
N-methyl-2-[1-[[5-methyl-3-(trifluoromethyl)-1H-pyrazol-1-yl]acetyl]-4-piperidinyl]-N-[(1R,4S)-1,2,3,4-tetrahydro-4-hydroxy-1-naphthalenyl]-4-thiazolecarboxamide and/or its enantiomer,
N-methyl-2-[1-[[5-methyl-3-(trifluoromethyl)-1H-pyrazol-1-yl]acetyl]-4-piperidinyl]-N-(1,2,3,4-tetrahydro-2-methyl-1-naphthalenyl)-4-thiazolecarboxamide,
N-methyl-2-[1-[[5-methyl-3-(trifluoromethyl)-1H-pyrazol-1-yl]acetyl]-4-piperidinyl]-N-[(1R,4R)-1,2,3,4-tetrahydro-4-hydroxy-1-naphthalenyl]-4-thiazolecarboxamide and/or its enantiomer(s),
2-[1-[[5-ethyl-3-(trifluoromethyl)-1H-pyrazol-1-yl]acetyl]-4-piperidinyl]-N-methyl-N-[(1R)-1,2,3,4-tetrahydro-1-naphthalenyl]-4-thiazolecarboxamide,
2-[1-[[3,5-bis(trifluoromethyl)-1H-pyrazol-1-yl]acetyl]-4-piperidinyl]-N-methyl-N-[(1R)-1,2,3,4-tetrahydro-1-naphthalenyl]-4-thiazolecarboxamide,
N-methyl-2-[1-[[5-methyl-3-(trifluoromethyl)-1H-pyrazol-1-yl]acetyl]-4-piperidinyl]-N-(1,2,3,4-tetrahydro-4-oxo-1-naphthalenyl)-4-thiazolecarboxamide,
N-methyl-2-[4-[[5-methyl-3-(trifluoromethyl)-1H-pyrazol-1-yl]acetyl]-1-piperazinyl]-N-[(1R)-1,2,3,4-tetrahydro-1-naphthalenyl]-4-thiazolecarboxamide,
N-(2,3-dihydro-2,2-dimethyl-1H-inden-1-yl)-N-methyl-2-[1-[[5-methyl-3-(trifluoro-methyl)-1H-pyrazol-1-yl]acetyl]-4-piperidinyl]-4-thiazolecarboxamide,
N-(2,3-dihydro-2-methyl-1H-inden-1-yl)-N-methyl-2-[1-[[5-methyl-3-(trifluoro-methyl)-1H-pyrazol-1-yl]acetyl]-4-piperidinyl]-4-thiazolecarboxamide,
N-methyl-1-[1-[[5-methyl-3-(trifluoromethyl)-1H-pyrazol-1-yl]acetyl]-4-piperidinyl]-N-[(1R)-1,2,3,4-tetrahydro-1-naphthalenyl]-1H-pyrazole-3-carboxamide,
N-methyl-2-[1-[[5-methyl-3-(trifluoromethyl)-1H-pyrazol-1-yl]acetyl]-4-piperidinyl]-N-[(1R)-1,2,3,4-tetrahydro-1-naphthalenyl]-2H-1,2,3-triazole-4-carboxamide,
N-methyl-1-[1-[[5-methyl-3-(trifluoromethyl)-1H-pyrazol-1-yl]acetyl]-4-piperidinyl]-N-[(1R)-1,2,3,4-tetrahydro-1-naphthalenyl]-1H-pyrazole-4-carboxamide,
N-methyl-2-[1-[[5-methyl-3-(trifluoromethyl)-1H-pyrazol-1-yl]acetyl]-4-piperidinyl]-N-[(1R,2S)-1,2,3,4-tetrahydro-2-methyl-1-naphthalenyl]-4-thiazolecarboxamide and/or its enantiomer,
N-methyl-2-[1-[[5-methyl-3-(trifluoromethyl)-1H-pyrazol-1-yl]acetyl]-4-piperidinyl]-N-(1,2,3,4-tetrahydro-2,2-dimethyl-1-naphthalenyl]-4-thiazolecarboxamide,
2-[1-[(3,5-dichloro-1H-pyrazol-1-yl)acetyl]-4-piperidinyl]-N-methyl-N-[(1R)-1,2,3,4-tetrahydro-1-naphthalenyl]-4-thiazolecarboxamide,
2-[1-[[5-chloro-3-(trifluoromethyl)-1H-pyrazol-1-yl]acetyl)-4-piperidinyl)-N-methyl-N-[(1R)-1,2,3,4-tetrahydro-1-naphthalenyl]-4-thiazolecarboxamide,
N-methyl-2-[1-[[5-methyl-3-(trifluoromethyl)-1H-pyrazol-1-yl)acetyl]-4-piperidinyl]-N-[(1R)-1,2,3,4-tetrahydro-1-naphthalenyl]-4-oxazolecarboxamide, and
N-methyl-2-[1-[[5-methyl-3-(trifluoromethyl)-1H-pyrazol-1-yl]acetyl]-4-piperidinyl]-N-(1,2,3,4-tetrahydro-1-naphthalenyl)-4-thiazolecarboxamide.

22. The mixture according to claim 21, wherein compound (I) is 2-{1-[2-(5-methyl-3-trifluoromethyl-pyrazol-1-yl)-acetyl]-piperidin-4-yl}-thiazole-4-carboxylic acid methyl-(R)-1,2,3,4-tetrahydro-naphthalen-1-yl-amide and/or its enantiomer.

23. The mixture according to claim 16, comprising as component (II) the compound 3-difluoromethyl-1-methyl-1H-pyrazole-4-carboxylic acid (3′,4′,5′-trifluorobiphenyl-2-yl)-amide.

24. The mixture according to claim 16, comprising as component (II) the compound 5-ethyl-6-octyl-[1,2,4]triazolo[1,5-a]pyrimidine-7-ylamine.

25. The mixture according to claim 16, comprising as component (II) the Bacillus subtilis strain with NRRL Accession No. B-21661, a mutant thereof having all the identifying characteristics of the strain, or a metabolite produced by the strain that exhibits activity against plant pathogenic fungi.

26. The mixture according to claim 16, comprising a compound (I) and a component II in a weight ratio of from 100:1 to 1:100.

27. An agrochemical composition, comprising a solvent or solid carrier and the mixture according to claim 16.

28. The composition according to claim 27, comprising at least one further active substance.

29. A method for combating phytopathogenic harmful fungi, which process comprises treating the fungi or the materials, plants, the soil or seeds to be protected against fungal attack, with an effective amount of at least one compound (I) and of a fungicidal component (II) as defined in claim 16.

30. The method of claim 29, wherein compound I is selected from the group consisting of:
2-[1-[(2,5-dimethylphenyl)acetyl]-4-piperidinyl]-N-methyl-N-[(1R)-1,2,3,4-tetrahydro-1-naphthalenyl]-4-thiazolecarboxamide,
2-[1-[(2,5-dichlorophenyl)acetyl]-4-piperidinyl]-N-methyl-N-[(1R)-1,2,3,4-tetrahydro-1-naphthalenyl]-4-thiazolecarboxamide,
N-methyl-2-[1-[[5-methyl-3-(trifluoromethyl)-1H-pyrazol-1-yl]acetyl]-4-piperidinyl]-N-[(1R)-1,2,3,4-tetrahydro-1-naphthalenyl]-4-thiazolecarboxamide,
N-[(1R)-2,3-dihydro-1H-inden-1-yl]-N-methyl-2-[1-[[5-methyl-3-(trifluoromethyl)-1H-pyrazol-1-yl]acetyl]-4-piperidinyl]-4-thiazolecarboxamide,
N-methyl-2-[1-[[5-methyl-3-(trifluoromethyl)-1H-pyrazol-1-yl]acetyl]-4-piperidinyl]-N-[(1R)-1,2,3,4-tetrahydro-1-naphthalenyl]-4-thiazolecarbothioamide,
N-methyl-2-[1-[[5-methyl-3-(trifluoromethyl)-1H-pyrazol-1-yl]acetyl]-4-piperidinyl]-N-[(1R,4S)-1,2,3,4-tetrahydro-4-hydroxy-1-naphthalenyl]-4-thiazolecarboxamide and/or its enantiomer,
N-methyl-2-[1-[[5-methyl-3-(trifluoromethyl)-1H-pyrazol-1-yl]acetyl]-4-piperidinyl]-N-(1,2,3,4-tetrahydro-2-methyl-1-naphthalenyl)-4-thiazolecarboxamide,
N-methyl-2-[1-[[5-methyl-3-(trifluoromethyl)-1H-pyrazol-1-yl]acetyl]-4-piperidinyl]-N-[(1R,4R)-1,2,3,4-tetrahydro-4-hydroxy-1-naphthalenyl]-4-thiazolecarboxamide and/or its enantiomer(s),
2-[1-[[5-ethyl-3-(trifluoromethyl)-1H-pyrazol-1-yl]acetyl]-4-piperidinyl]-N-methyl-N-[(1R)-1,2,3,4-tetrahydro-1-naphthalenyl]-4-thiazolecarboxamide,
2-[1-[[3,5-bis(trifluoromethyl)-1H-pyrazol-1-yl]acetyl]-4-piperidinyl]-N-methyl-N-[(1R)-1,2,3,4-tetrahydro-1-naphthalenyl]-4-thiazolecarboxamide,
N-methyl-2-[1-[[5-methyl-3-(trifluoromethyl)-1H-pyrazol-1-yl]acetyl]-4-piperidinyI]-N-(1,2,3,4-tetrahydro-4-oxo-1-naphthalenyl)-4-thiazolecarboxamide,
N-methyl-2-[4-[[5-methyl-3-(trifluoromethyl)-1H-pyrazol-1-yl]acetyl]-1-piperazinyl]-N-[(1R)-1,2,3,4-tetrahydro-1-naphthalenyl]-4-thiazolecarboxamide,
N-(2,3-dihydro-2,2-dimethyl-1H-inden-1-yl)-N-methyl-2-[1-[[5-methyl-3-(trifluoro-methyl)-1H-pyrazol-1-yl]acetyl]-4-piperidinyl]-4-thiazolecarboxamide,
N-(2,3-dihydro-2-methyl-1H-inden-1-yl)-N-methyl-2-[1-[[5-methyl-3-(trifluoro-methyl)-1H-pyrazol-1-yl]acetyl]-4-piperidinyl]-4-thiazolecarboxamide,
N-methyl-1-[1-[[5-methyl-3-(trifluoromethyl)-1H-pyrazol-1-yl]acetyl]-4-piperidinyl]-N-[(1R)-1,2,3,4-tetrahydro-1-naphthalenyl]-1H-pyrazole-3-carboxamide,
N-methyl-2-[1-[[5-methyl-3-(trifluoromethyl)-1H-pyrazol-1-yl]acetyl]-4-piperidinyl]-N-[(1R)-1,2,3,4-tetrahydro-1-naphthalenyl]-2H-1,2,3-triazole-4-carboxamide,
N-methyl-1-[1-[[5-methyl-3-(trifluoromethyl)-1H-pyrazol-1-yl]acetyl]-4-piperidinyl]-N-[(1R)-1,2,3,4-tetrahydro-1-naphthalenyl]-1H-pyrazole-4-carboxamide,
N-methyl-2-[1-[[5-methyl-3-(trifluoromethyl)-1H-pyrazol-1-yl]acetyl]-4-piperidinyl]-N-[(1R,2S)-1,2,3,4-tetrahydro-2-methyl-1-naphthalenyl]-4-thiazolecarboxamide and/or its enantiomer,
N-methyl-2-[1-[[5-methyl-3-(trifluoromethyl)-1H-pyrazol-1-yl]acetyl]-4-piperidinyl]-N-(1,2,3,4-tetrahydro-2,2-dimethyl-1-naphthalenyl]-4-thiazolecarboxamide,
2-[1-[(3,5-dichloro-1H-pyrazol-1-yl)acetyl]-4-piperidinyl]-N-methyl-N-[(1R)-1,2,3,4-tetrahydro-1-naphthalenyl]-4-thiazolecarboxamide,
2-[1-[[5-chloro-3-(trifluoromethyl)-1H-pyrazol-1-yl]acetyl)-4-piperidinyl)-N-methyl-N-[(1R)-1,2,3,4-tetrahydro-1-naphthalenyl]-4-thiazolecarboxamide,
N-methyl-2-[1-[[5-methyl-3-(trifluoromethyl)-1H-pyrazol-1-yl)acetyl]-4-piperidinyl]-N-[(1R)-1,2,3,4-tetrahydro-1-naphthalenyl]-4-oxazolecarboxamide, and
N-methyl-2-[1-[[5-methyl-3-(trifluoromethyl)-1H-pyrazol-1-yl]acetyl]-4-piperidinyl]-N-(1,2,3,4-tetrahydro-1-naphthalenyl)-4-thiazolecarboxamide.

31. The method of claim 30, wherein compound (I) is 2-{1-[2-(5-methyl-3-trifluoromethyl-pyrazol-1-yl)-acetyl]-piperidin-4-yl}-thiazole-4-carboxylic acid methyl-(R)-1,2,3,4-tetrahydro-naphthalen-1-yl-amide and/or its enantiomer.

32. The method of claim 29, comprising as component (II) the compound 3-difluoromethyl-1-methyl-1H-pyrazole-4-carboxylic acid (3′,4′,5′-trifluorobiphenyl-2-yl)-amide.

33. The method of claim 29, comprising as component (II) the compound 5-ethyl-6-octyl-[1,2,4]triazolo[1,5-a]pyrimidine-7-ylamine.

34. The method of claim 29, comprising as component (II) the Bacillus subtilis strain with NRRL Accession No. B-21661, a mutant thereof having all the identifying characteristics of the strain, or a metabolite produced by the strain that exhibits activity against plant pathogenic fungi.

35. Plant propagation material treated with the mixture according to claim 16 in an amount of from 0.1 g to 10,000 g active compounds per 100 kg of plant propagation material.
